(19) United States
(12) Patent Application Publication
(10) Pub. No.: US 2015/0308348 A1
(43) Pub. Date: Oct. 29, 2015

(54) CONTINUOUS DETONATION WAVE TURBINE ENGINE

(71) Applicant: United Technologies Corporation, Hartford, CT (US)

(72) Inventor: Alan B. Minick, Madison, AL (US)

(73) Assignee: United Technologies Corporation, Hartford, CT (US)

(21) Appl. No.: 14/285,068

(22) Filed: May 22, 2014

Related U.S. Application Data
(60) Provisional application No. 61/826,296, filed on May 22, 2013.

(51) Int. Cl. F02C 7/264; F02C 3/14; F23R 3/02; F02C 3/06

(52) U.S. Cl. CPC F02C 7/264; F02C 3/06; F02C 3/14; F23R 3/02; F05D 2220/32; F05D 2240/35; F23R 2900/00008

(57) ABSTRACT

A gas turbine engine includes a transient plasma igniter in communication with a continuous detonation wave combustor. A method of operating a gas turbine engine includes maintaining ignition of a continuous detonation wave combustor with a transient plasma igniter.

### CROSS-REFERENCE TO RELATED APPLICATIONS

This application claims priority to U.S. Provisional Patent Appln. No. 61/826,296 filed May 22, 2013, which is hereby incorporated herein by reference in its entirety.

### BACKGROUND

The present disclosure generally relates generally to a gas turbine engine architecture, and more specifically to a turbine engine with a continuous detonation wave combustor.

Gas turbine engines, such as those that power modern commercial and military aircraft, generally include a compressor section to pressurize an airflow, a combustor section to burn a hydrocarbon fuel in the presence of the pressurized air, and a turbine section to extract energy from the resultant combustion gases.

The compressor section is often relatively long and includes numerous stages to achieve the desired compression ratios. Alternate engine architectures may utilize centrifugal compression technology to reduce the required length, but are of a relatively significant diameter to achieve desired compression ratios. Large diameter gas turbine engine architectures increase weight and frontal area which typically relegates such engine architectures to subsonic applications.

### SUMMARY OF THE DISCLOSURE

According to an aspect of the invention, a gas turbine engine is provided that includes a tip turbine engine compressor, a continuous detonation wave combustor, a turbine and a transient plasma ignitor. The continuous detonation wave combustor is in fluid communication with and downstream of the compressor. The turbine is in fluid communication with and downstream of the continuous detonation wave combustor. The transient plasma ignitor is in communication with the continuous detonation wave combustor.

According to another aspect of the invention, another gas turbine engine is provided that includes a continuous detonation wave combustor and a transient plasma ignitor. The transient plasma ignitor is in communication with said continuous detonation wave combustor.

According to still another aspect of the invention, a method is provided for operating a gas turbine engine. This method includes maintaining ignition of a continuous detonation wave combustor with a transient plasma igniter.

The gas turbine engine may include a high bypass fan section upstream of said tip turbine engine compressor.

The gas turbine engine may include a centrifugal compressor gas turbine engine architecture.

The gas turbine engine may include a fan-turbine rotor assembly with a multiple of hollow fan blades to provide internal, centrifugal compression of a compressed airflow to the continuous detonation wave combustor.

The gas turbine engine may include an axial compressor axially forward of the fan-turbine rotor assembly.

The continuous detonation wave combustor may be radially outboard of the multiple of hollow fan blades.

Each of the hollow fan blades may include a fan blade core airflow passage generally perpendicular to an axis of rotation of the fan-turbine rotor assembly.

The gas turbine engine may include a high bypass fan section.

The method may include internally compressing an airflow within a fan-turbine rotor assembly. The method may also include communicating the airflow from the fan-turbine rotor assembly to the continuous detonation wave combustor.

The method may include axially compressing the airflow upstream of the fan-turbine rotor assembly.

The method may include generating a compression ratio of about forty to one (40:1) within the continuous detonation wave combustor.

The method may include centrifugally compressing an airflow within a high bypass gas turbine engine architecture.

The method may include centrifugally compressing an airflow within a low bypass gas turbine engine architecture.

The foregoing features and the operation of the invention will become more apparent in light of the following description and the accompanying drawings.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a partial sectional perspective view of a tip turbine engine;

FIG. 2 is a longitudinal sectional view of a tip turbine engine along an engine centerline;

FIG. 3 is a schematic view of an annular continuous detonation wave combustor;

FIG. 4 is a partial schematic view of another annular continuous detonation wave combustor for a gas turbine engine architecture; and

FIG. 5 is a partial schematic view of still another annular continuous detonation wave combustor for a gas turbine engine architecture.

### DETAILED DESCRIPTION

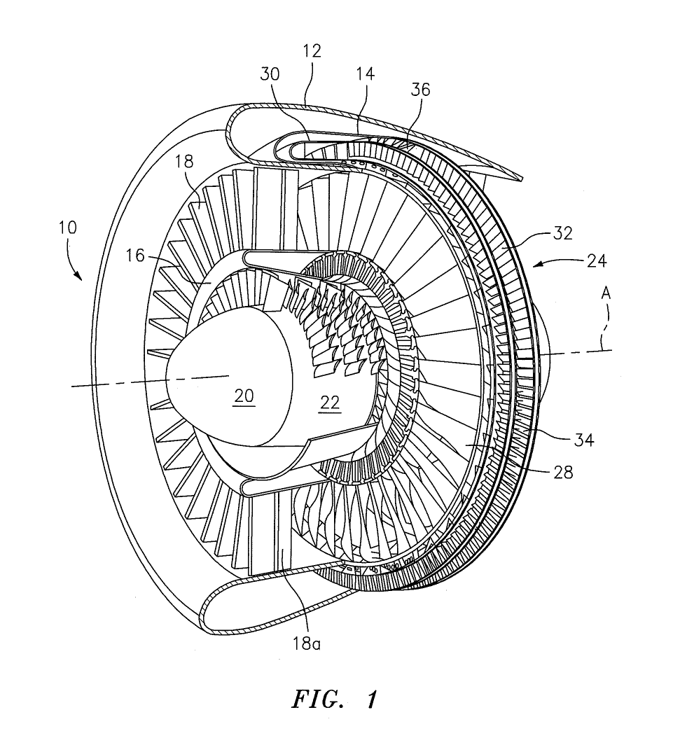

FIG. 1 schematically illustrates a perspective partial sectional view of a tip turbine engine type gas turbine engine 10. Although depicted as a high bypass tip turbine engine in the disclosed non-limiting embodiment, it should be understood that the teachings herein may also be applied to other types of turbine engine architectures.

The engine 10 generally includes an outer nacelle 12, a rotationally fixed static outer support structure 14 and a rotationally fixed static inner support structure 16. A multiple of fan inlet guide vanes 18 are mounted between the static outer support structure 14 and the static inner support structure 16. Each inlet guide vane 18 may include a fixed or variable trailing edge 18A.

A nose cone 20 is located along a centerline A of the engine 10 to smoothly direct airflow into an axial tip turbine compressor 22 adjacent thereto. The axial tip turbine compressor 22 is mounted about the engine centerline A axially aft of the nose cone 20.

A fan-turbine rotor assembly 24 is mounted for rotation about the engine centerline A axially aft of the axial tip turbine compressor 22. The fan-turbine rotor assembly 24 includes a multiple of hollow fan blades 28 to provide internal, centrifugal compression of the compressed airflow from the axial tip turbine engine compressor 22 for distribution to a combustor section 30 located within the rotationally fixed static outer support structure 14.

A turbine 32 includes a multiple of tip turbine blades 34 (two stages shown) which rotatably drive the hollow fan blades 28 relative a multiple of tip turbine stators 36, which extend radially inwardly from the static outer support structure 14. The combustor section 30 is radially outboard of the multiple of hollow fan blades 28 and the axially forward of the turbine 32.

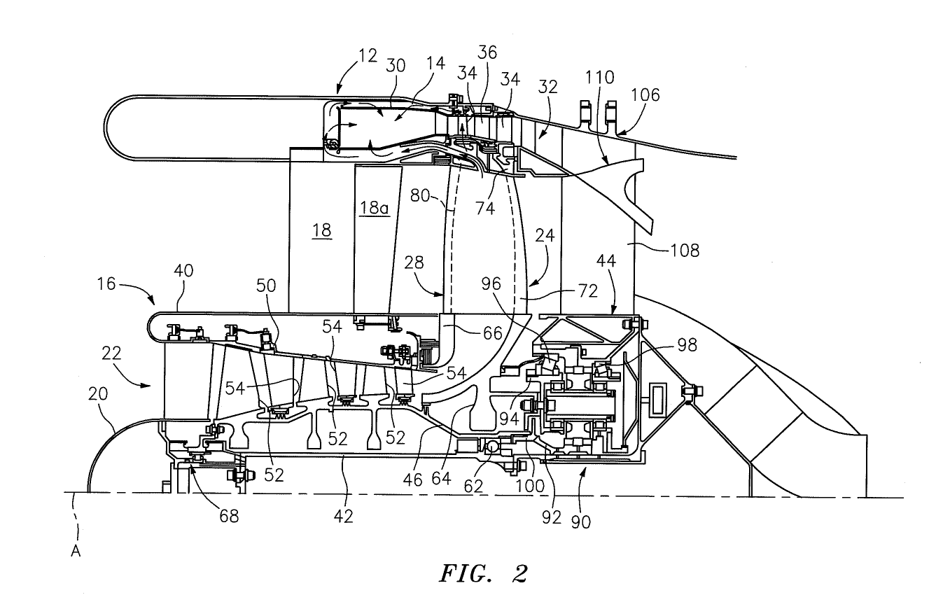

With reference to FIG. 2, the rotationally fixed static inner support structure 16 includes a splitter 40, a static inner support housing 42 and a static outer support housing 44 located coaxial to the engine centerline A.

The axial tip turbine compressor 22 includes the axial compressor rotor 46 from which a plurality of compressor blades 52 extend radially outwardly. The axial tip turbine compressor 22 also includes a compressor case 50 fixedly mounted to the splitter 40. A plurality of compressor vanes 54 extend radially inwardly from the compressor case 50 between stages of the compressor blades 52. The compressor blades 52 and compressor vanes 54 are arranged circumferentially about the axial compressor rotor 46 in stages (three stages of compressor blades 52 and compressor vanes 54 are shown in this example). The axial compressor rotor 46 is mounted for rotation upon the static inner support housing 42 through a forward bearing assembly 68 and an aft bearing assembly 62.

The fan-turbine rotor assembly 24 includes a fan hub 64 that supports a multiple of the hollow fan blades 28. Each fan blade 28 includes an inducer section 66, a hollow fan blade section 72 and a diffuser section 74. The inducer section 66 receives airflow from the axial tip turbine compressor 22 generally parallel to the engine centerline A and turns the airflow from an axial airflow direction toward a radial airflow direction. The airflow is radially communicated through a core airflow passage 80 within the fan blade section 72 where the airflow is centrifugally compressed. From the core airflow passage 80, the airflow is turned and diffused toward an axial airflow direction toward the annular combustor 30. In one disclosed non-limiting embodiment, the airflow is diffused axially forward in the engine 10; however, the airflow may alternatively be communicated in alternative or additional directions.

A gearbox assembly 90 aft of the fan-turbine rotor assembly 24 provides a speed increase between the fan-turbine rotor assembly 24 and the axial tip turbine compressor 22. Alternatively, the gearbox assembly 90 could provide a speed decrease between the fan-turbine rotor assembly 24 and the axial compressor rotor 46. The gearbox assembly 90 is mounted for rotation between the static inner support housing 42 and the static outer support housing 44. The gearbox assembly 90 includes a sun gear shaft 92 which rotates with the axial tip turbine compressor 22 and a planet carrier 94 which rotates with the fan-turbine rotor assembly 24 to provide a speed differential therebetween. The gearbox assembly 90 may be a planetary gearbox that provides co-rotating or counter-rotating rotational engagement between the fan-turbine rotor assembly 24 and the axial compressor rotor 46. The gearbox assembly 90 is mounted for rotation between the sun gear shaft 92 and the static outer support housing 44 through a forward bearing 96 and a rear bearing 98. The forward bearing 96 and the rear bearing 98 are both tapered roller bearings and both hand radial loads. The forward bearing 96 handles the aft axial loads while the rear bearing 98 handles the forward axial loads. The sun gear shaft 92 is rotationally engaged with the axial compressor rotor 46 at a splined interconnection 100 or the like.

In operation, air enters the axial tip turbine compressor 22, and is compressed by the three stages of the compressor blades 52 and compressor vanes 54. The compressed air from the axial tip turbine compressor 22 enters the inducer section 66 in a direction generally parallel to the engine centerline A and is turned by the inducer section 66 radially outwardly through the core airflow passage 80 of the hollow fan blades 28. The airflow is further compressed centrifugally within the hollow fan blades 28 by rotation of the hollow fan blades 28. From the core airflow passage 80, the airflow is turned and diffused axially forward into the annular combustor 30. The compressed core airflow from the hollow fan blades 28 is mixed with fuel in the combustor section 30 and ignited to form a high-energy gas stream. The high-energy gas stream is expanded over the multiple of tip turbine blades 34 mounted about the outer periphery of the fan-turbine rotor assembly 24 to drive the fan-turbine rotor assembly 24, which in turn drives the axial tip turbine compressor 22 through the gearbox assembly 90. Concurrent therewith, the fan-turbine rotor assembly 24 discharges fan bypass air axially aft to merge with the core airflow from the turbine 32 in an exhaust case 106. A multiple of exit guide vanes 108 are located between the static outer support housing 44 and the rotationally fixed static outer support structure 14 to guide the combined airflow out of the engine 10 to provide forward thrust. An exhaust mixer 110 mixes the airflow from the turbine blades 34 with the bypass airflow through the fan blades 28.

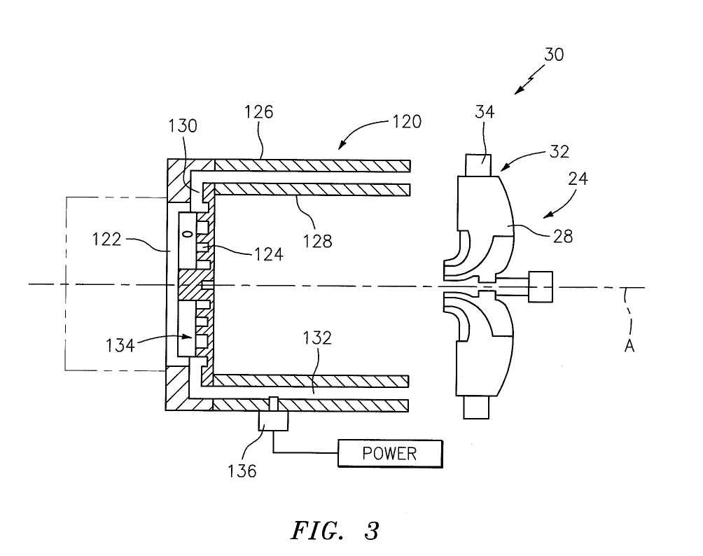

With reference to FIG. 3, the combustor section 30 includes an annular continuous detonation wave combustor 120. The continuous detonation wave combustor 120 derives energy from a continuous wave of detonation. In other words, for a detonation engine as compared to a conventional combustor which operates on the deflagration of fuel, the oxygen and fuel combustion process of the continuous detonation wave combustor 120 is effectively an explosion instead of burning.

A primary difference between deflagration and detonation is linked to the mechanism of the flame propagation. In deflagration, the flame propagation is a function of the heat transfer from the reactive zone to the fresh mixture (generally conduction). The detonation is a shock induced flame, which results in the coupling of a reaction zone and a shock wave. The shock wave compresses and heats the fresh mixture, for an increase above the self-ignition point. On the other side, the energy released by the flame contributes to the propagation of the shock wave.

By way of further explanation, continuous detonation is a detonation wave propagating around a closed circuit in a continuous manner which globally operates at very high frequency (e.g., typically several kHz) and are dephased so the mean pressure inside the chamber is higher than for typical combustion system.

The continuous detonation wave combustor 120 generally includes a fuel plenum 122, an air diffuser 124, an outer cylindrical wall 126, and an inner cylindrical wall 128. The space between air diffuser 124 and the outer cylindrical wall 126 operates as a mixing chamber 130, and the space between the inner cylindrical wall 128 and outer cylindrical wall 126 servers as a combustion chamber 132. An annular chamber 134 in the fuel plenum 122 serves as a fuel chamber. In one embodiment, the outer cylindrical wall 126 includes a cooling system 136 (illustrated schematically) to facilitate thermal management.

A transient plasma igniter 136 (illustrated schematically in FIG. 3) communicates with the combustion chamber 132. Transient plasma igniters—and may be referred to as pulsed corona discharges—generate multiple streamers of electrons at high energy which readily facilitates stability of the detonation process along the combustion chamber 132. That is, the transient plasma igniter 136 assists in sustainment of continuous detonation operations in air rather than an oxygen enriched oxidizer supply. Although the transient plasma igniter 136 is schematically illustrated in a single particular location, it should be appreciated that multiple locations as well as other locations for the transient plasma igniter 136 may also be provided.

In one disclosed non-limiting embodiment, the igniter 136 operates continuously—not just for ignition—to further facilitate stability of the detonation process which continues substantially without interruption, as one or more waves of detonation continuously propagate around the combustion chamber 132, consuming the air/fuel mixture, while fresh mixture is continually introduced into the combustion chamber 132. This assists to sustain the detonation wave or waves to continually cycle around the combustion chamber 132.

The continuous detonation wave combustor 120 continuously combusts the mixed gas with the one or more detonation waves that propagate normally to the reaction front to generate a rotational flow that facilitates rotation of the turbine 32. That is, the significant tangential component to the exhaust vector of the continuous detonation wave combustor 120 beneficially increases the motive force to drive the turbine 32.

The continuous detonation wave combustor 120 also advantageously provides significant compression ratios, which in one disclosed non-limiting embodiment are on the order of up to forty to one (40:1) to raise a two (2) to three (3) atmospheric pressure from the axial tip turbine compressor 22 to as much as about one hundred twenty (120) atmospheres. This compares to a thirteen to eighteen (13:1-18-1) compression ratio typical of a conventional gas turbine engine combustor sections.

With the continuous detonation wave combustor 120, the tip turbine engine architecture is readily scalable for greater speeds and thrust ranges as high operational compression ratios are provided within relatively small engine diameters. Military and supersonic tip turbine engine architectures are thereby facilitated. In other words, the transient plasma igniter 136 stabilizes combustion in the continuous detonation wave combustor 120 and the continuous detonation wave combustor 120 increases compression and makes use of the tangential exhaust within the tip turbine engine architecture to provides a short, small, lightweight propulsion system with good thrust specific fuel consumption.

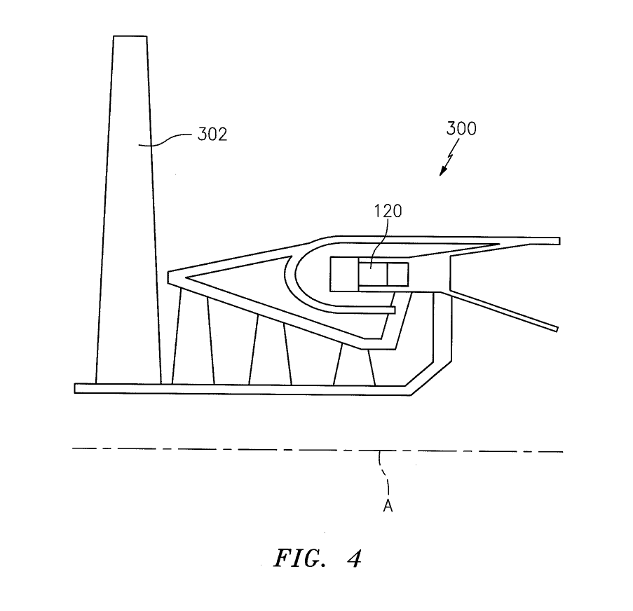

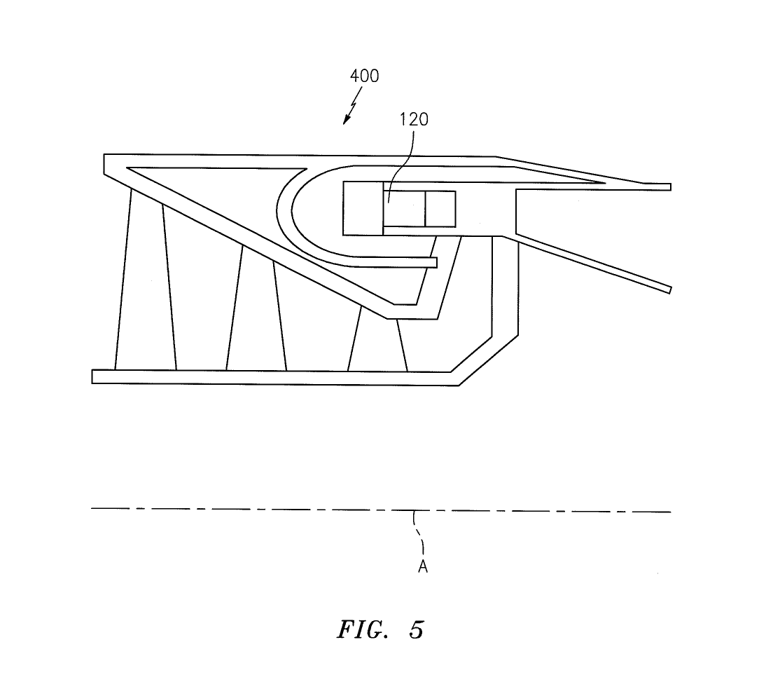

Alternate engine architectures such as a centrifugal compressor gas turbine engine architecture 300 with a fan section 302 (see FIG. 4) and a low bypass centrifugal compressor gas turbine engine architecture 400 (see FIG. 5) and others will also benefit herefrom.

The use of the terms “a” and “an” and “the” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to the normal operational attitude of a vehicle (e.g., aircraft) and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described and claimed, it should be understood that steps may be performed in any order, separated or combined unless otherwise indicated and will still benefit from the present disclosure.

The foregoing description is exemplary rather than defined by the features within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A gas turbine engine, comprising:
a tip turbine engine compressor;
a continuous detonation wave combustor in fluid communication with and downstream of said compressor;
a turbine in fluid communication with and downstream of said continuous detonation wave combustor; and
a transient plasma ignitor in communication with said continuous detonation wave combustor.

2. The gas turbine engine as recited in claim 1, further comprising a high bypass fan section upstream of said tip turbine engine compressor.

3. The gas turbine engine as recited in claim 1, further comprising a centrifugal compressor gas turbine engine architecture.

4. A gas turbine engine, comprising:
a continuous detonation wave combustor; and
a transient plasma ignitor in communication with said continuous detonation wave combustor.

5. The gas turbine engine as recited in claim 4, further comprising a fan-turbine rotor assembly with a multiple of hollow fan blades to provide internal, centrifugal compression of a compressed airflow to said continuous detonation wave combustor.

6. The gas turbine engine as recited in claim 5, further comprising an axial compressor axially forward of said fan-turbine rotor assembly.

7. The gas turbine engine as recited in claim 5, wherein said continuous detonation wave combustor is radially outboard of said multiple of hollow fan blades.

8. The gas turbine engine as recited in claim 5, wherein each of said multiple of hollow fan blades include a fan blade core airflow passage generally perpendicular to an axis of rotation of said fan-turbine rotor assembly.

9. The gas turbine engine as recited in claim 4, further comprising a centrifugal compressor gas turbine engine architecture.

10. The gas turbine engine as recited in claim 9, further comprising a high bypass fan section.

11. A method of operating a gas turbine engine, the method comprising:
maintaining ignition of a continuous detonation wave combustor with a transient plasma igniter.

12. The method as recited in claim 11, further comprising:
internally compressing an airflow within a fan-turbine rotor assembly; and
communicating the airflow from the fan-turbine rotor assembly to the continuous detonation wave combustor.

13. The method as recited in claim 12, further comprising:
axially compressing the airflow upstream of the fan-turbine rotor assembly.

14. The method as recited in claim 11, further comprising:
generating a compression ratio of about forty to one (40:1) within the continuous detonation wave combustor.

15. The method as recited in claim 11, further comprising:
centrifugally compressing an airflow within a high bypass gas turbine engine architecture.

16. The method as recited in claim 11, further comprising:
centrifugally compressing an airflow within a low bypass gas turbine engine architecture.
